(19) United States
(12) Patent Application Publication
(10) Pub. No.: US 2026/0036776 A1
(43) Pub. Date: Feb. 5, 2026

(54) Fiber Cassette Base Housing Including Multiple Connectivity Options

(71) Applicant: Panduit Corp., Tinley Park, IL (US)

(72) Inventor: Alex C. Brouwer, New Lenox, IL (US)

(73) Assignee: Panduit Corp., Tinley Park, IL (US)

(21) Appl. No.: 18/791,591

(22) Filed: Aug. 1, 2024

(51) Int. Cl. G02B 6/44

(52) U.S. Cl. CPC G02B 6/4453

(57) ABSTRACT

A fiber cassette module includes a front portion with front openings and mounting features for enabling installation of multiple different adapter options. This fiber cassette module is therefore adaptable to provide different fiber cabling configurations using different adapter types.

### FIELD OF TECHNOLOGY

This disclosure relates to a fiber cassette module including a front portion with front openings and mounting features for enabling installation of multiple different adapter options.

### BACKGROUND

Data center systems are being developed for communicating large scale data over longer distances and higher bandwidths, and at faster speeds. To support such data center projects, a large amount of fiber optic cable is utilized for routing the data, where all the cable being utilized must be carefully managed. So, part of a data center's cable management solution may include racks for holding fiber cassette modules that help manage the fiber cables being used for transmission of incoming and outgoing data into the data center.

Within the field of fiber optic cable and cassette modules, there have been different connector and adapter types, each having their own unique physical characteristics. For example, there are LC, SC, MPO, and SN types of connector/adapter types that are being utilized in the field currently. Previous cassette modules would include mounting features for enabling installation of one type of adapter, thus preventing an installer from using the same cassette module to install fiber cables having a different type of connector.

### SUMMARY

An adaptive fiber cassette module is disclosed that includes front-side openings and mounting features that enable the installation of multiple different types of adapters.

According to an embodiment, the adaptive fiber cassette module comprises a first side wall, a second side wall, a bottom floor, a rear wall, and a front portion, the front portion including a front face, a front ceiling, a plurality of front openings, a first set of mounting features, and a second set of mounting features.

### BRIEF DESCRIPTION OF THE DRAWINGS

FIG. 1 is a perspective view of a cassette module, according to an exemplary embodiment.

FIG. 2A is a bottom view of the cassette module shown in FIG. 1, according to an exemplary embodiment.

FIG. 2B is magnified view of a front portion from the cassette module shown in FIG. 2A, according to an exemplary embodiment.

FIG. 3A is a perspective view of a cassette module and connector adapters for installing into front openings of the cassette module, according to an exemplary embodiment.

FIG. 3B is magnified view of a front portion from the cassette module shown in FIG. 3A, according to an exemplary embodiment.

FIG. 4 is a front side view of the cassette module shown in FIG. 1, according to an exemplary embodiment.

FIG. 5 is a perspective view of a cassette module including a first type of connector adapters installed into front openings of the cassette module, according to an exemplary embodiment.

FIG. 6 is a perspective view of a cassette module including a second type of connector adapters installed into front openings of the cassette module, according to an exemplary embodiment.

FIG. 7 is a perspective view of a cassette module including a third type of connector adapters installed into front openings of the cassette module, according to an exemplary embodiment.

FIG. 8A is a perspective view of a cassette module, according to an exemplary embodiment.

FIG. 8B is a magnified view of a rear portion from the cassette module shown in FIG. 8A, according to an exemplary embodiment.

### DETAILED DESCRIPTION

This disclosure describes embodiments of an adaptive fiber cassette module configured to enable installation of more than one different types of fiber connector adapters. So, whereas previous types of cassette modules would only allow for the installation of a single predetermined type of connector adapter, the present adaptive fiber cassette module includes front openings and mounting features to enable the installation of more than one type of connector adapter.

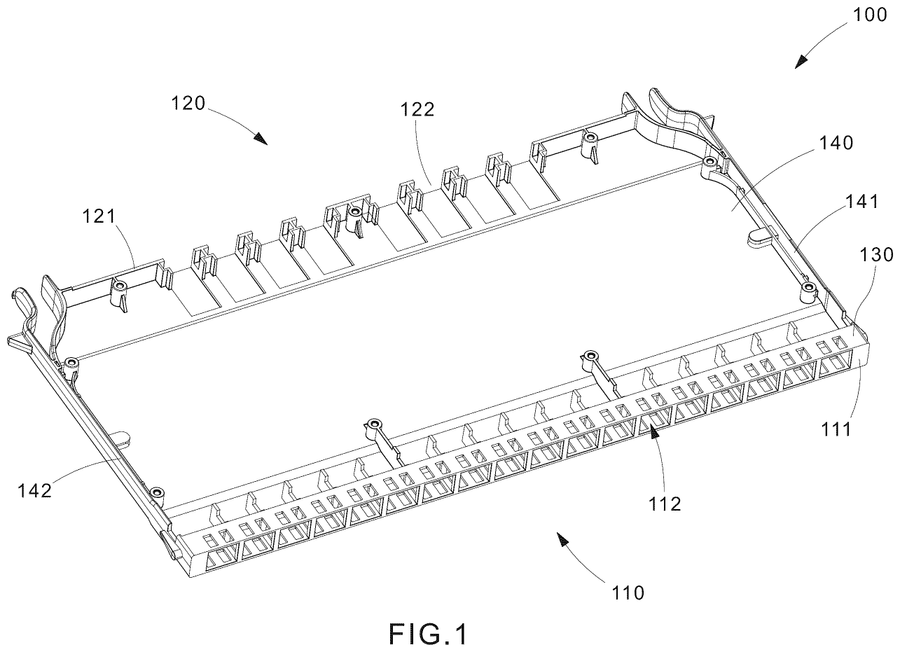

FIG. 1 illustrates a perspective view of an exemplary adaptive fiber cassette module 100 (hereinafter may be referred to as “cassette module”), according to an embodiment. The cassette module 100 may be used to manage fiber optic cable for transmitting and/or receiving data. The cassette module 100 includes a front portion 110 including a front face 111, the front face 111 including one or more front openings 112 (e.g., FIG. 1 shows the cassette module 100 including 18 front openings). The front openings 112 are configured to install different types of adapters for receiving different types of fiber connectors, as will be described in more detail. For example, the rear openings 112 may be configured to install duplex adapters for receiving duplex fiber connectors such as a duplex LC adapter, duplex SC adapter, or duplex SN adapter.

The cassette module 100 also includes a rear portion 120 including a rear wall 121, the rear wall 121 including one or more rear openings 122. The rear openings 122 are configured to install one or more different types of adapters for receiving one or more different types of fiber connectors, as will be described in more detail. For example, the rear openings 122 may be configured to install a multi-fiber adapter such as an MPO type adapter.

The cassette module 100 also includes a floor 140, a first side wall 141, and a second side wall 142 that is opposite to the first side wall 141. The floor 140, the first side wall 141, the second side wall 142, the front face 111, and the rear wall 121, and a top cover (not illustrated) together form a cassette housing to the cassette module 100.

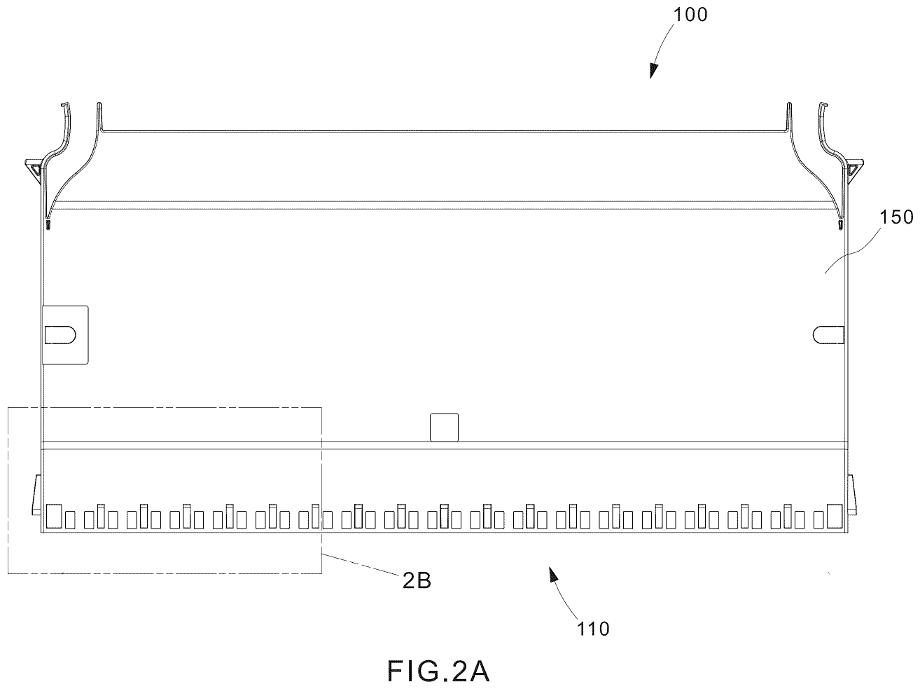

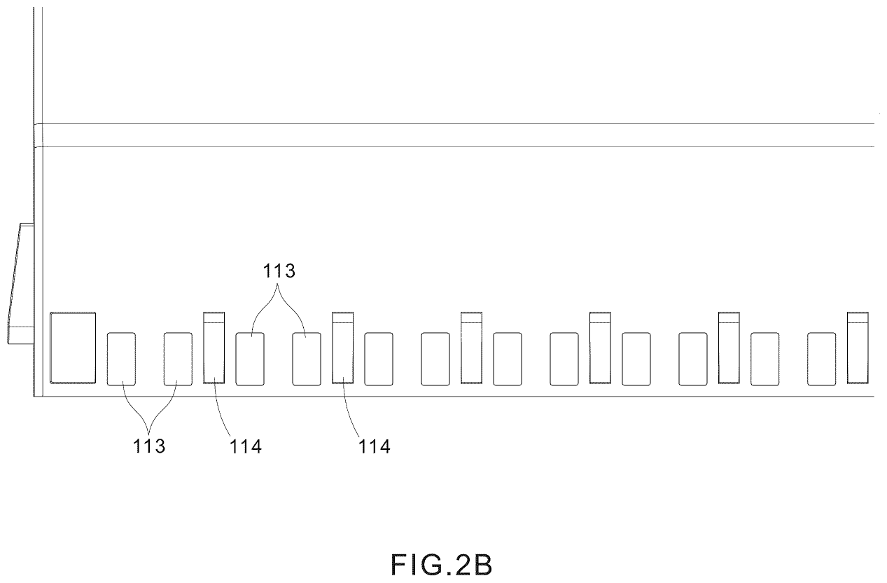

FIG. 2A is a bottom view showing a bottom side 150 of the cassette module 100. FIG. 2B is a magnified view of a portion 2B taken from a bottom of the front portion 110 of the cassette module. The bottom side 150 of the front portion 110 is shown to include more than one latching mounting features. For example, the bottom side 150 includes standard LC latch mounting features 113. The LC latch mounting features 113 may be openings configured to receive bottom-side latches from a duplex LC adapter. The standard LC latch mounting features 113 are spaced along a width of the bottom side 150 so that each front opening 112 has a corresponding set of LC latch mounting features 113.

The bottom side 150 also includes SC latch mounting features 114. The SC latch mounting features 114 may indicate a location of a front mounting wall 116, where the front mounting wall 116 provides the direct mounting features for engaging side latches on a duplex SC adapter. The standard SC latch mounting features 114 are spaced along a width of the bottom side 150 so that each front opening 112 has a corresponding set of SC latch mounting features 114. Although the front mounting wall 116 is described primarily as a mounting feature for SC type adapters, the front mounting wall 116 may also be utilized as a mounting feature for different types of adapters such as, for example, an MPO type adapter.

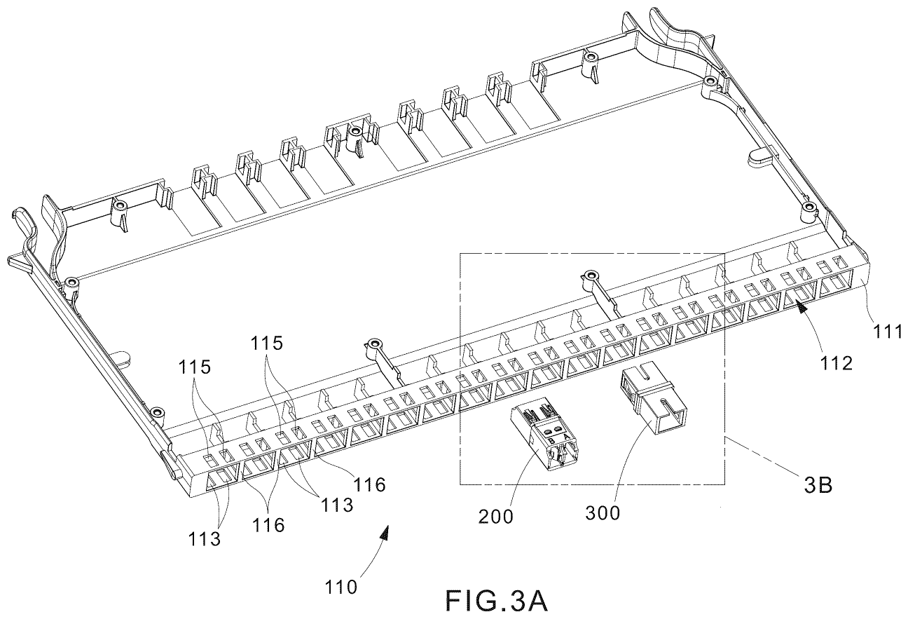

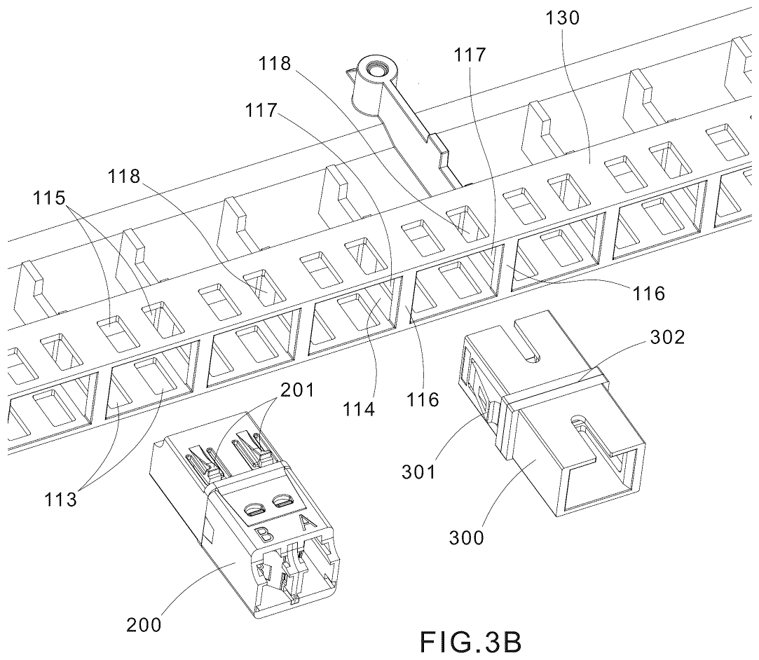

FIG. 3A is a top-down perspective view of the cassette module 100 showing different types of mounting features on a front ceiling 130 and the front face 111. For example, the front ceiling is shown to include LC latch mounting features 115, and the front face 111 is shown to include front wall SC latch mounting features 116. A more detailed view of how an exemplary LC adapter 200 and an exemplary SC adapter 300 may be installed into a front opening 112 is provided by the magnified view of portion 3B shown in FIG. 3B.

The LC latch mounting features 115 may be openings configured to receive top-side latches from a duplex LC adapter. The standard LC latch mounting features 115 are spaced along a width of the bottom side so that each front opening 112 has a corresponding set of LC latch mounting features 115. For example, the LC adapter 200 is shown to include top-side latches 201 that are configured to fit into the LC latch mounting features 115 at the top-side of a front opening 112. The same front opening 112 includes LC latch mounting features 113 on a bottom-side for receiving bottom-side latches (not illustrated) that may be included in the LC adapter 200.

The front wall SC latch mounting features 116 are sections of the front face 111 that are positioned to engage with side latches 301 that are included on both sides of the SC adapter 300. A rim 302 on the SC adapter may be configured to rest against the front wall SC latch mounting features 116 when the SC adapter is installed into the front opening 112. The wall behind the SC latch mounting features 116 may include an opening 117 for the side latches 301 to fit into when installed. The wall behind the SC latch mounting features 116 may also include a rear post 118.

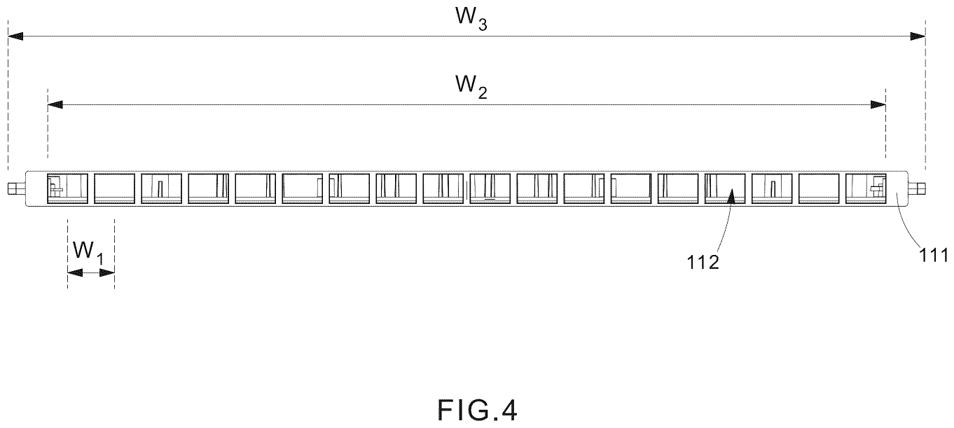

FIG. 4 shows a front-side view of the cassette module 100, where certain dimensional widths are described. A width of each front opening 112 is configured to accept at least two different adapter types taken from, but not limited to, LC adapter types, SC adapter types, SN adapter types, or MPO adapter types. To accommodate the ability to install more than one type of adapter, the center-to-center spacing between adjacent front openings 112 in the cassette module 100 is also increased compared to other cassette modules that only enable installation of a single type of adapter (e.g., only LC adapters). This provides enough room for adjacent SC adapters 300 to snap into the front openings 112 using the side latches 301 of the SC adapters 300.

So, the center-to-center spacing width W₁ between the front openings 112 may be approximately 0.613 inches. A width W₂ between a leftmost and rightmost front opening 112 may be approximately 10.946 inches, and a width W₃ of the overall cassette module 100 may be approximately 11.978 inches.

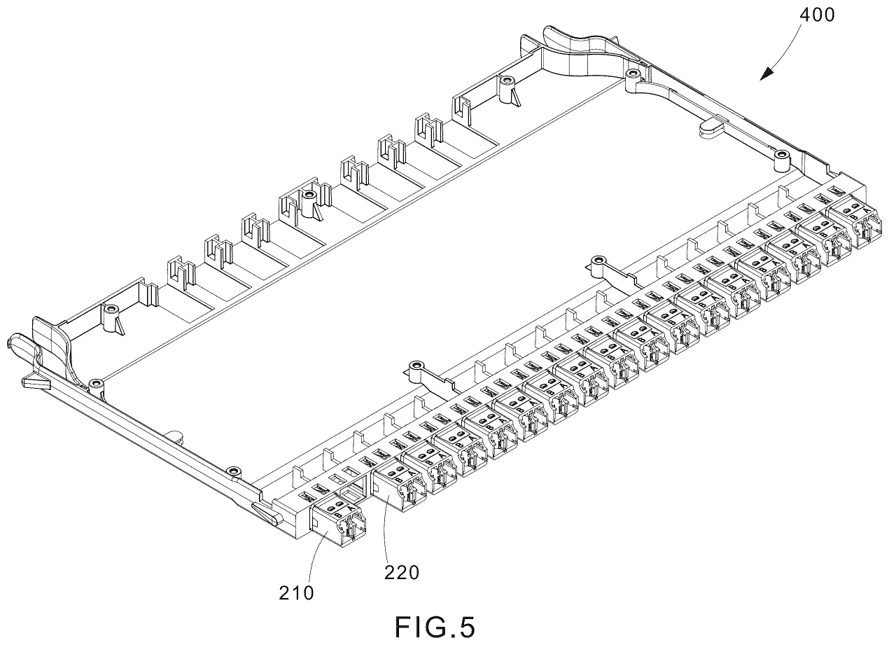

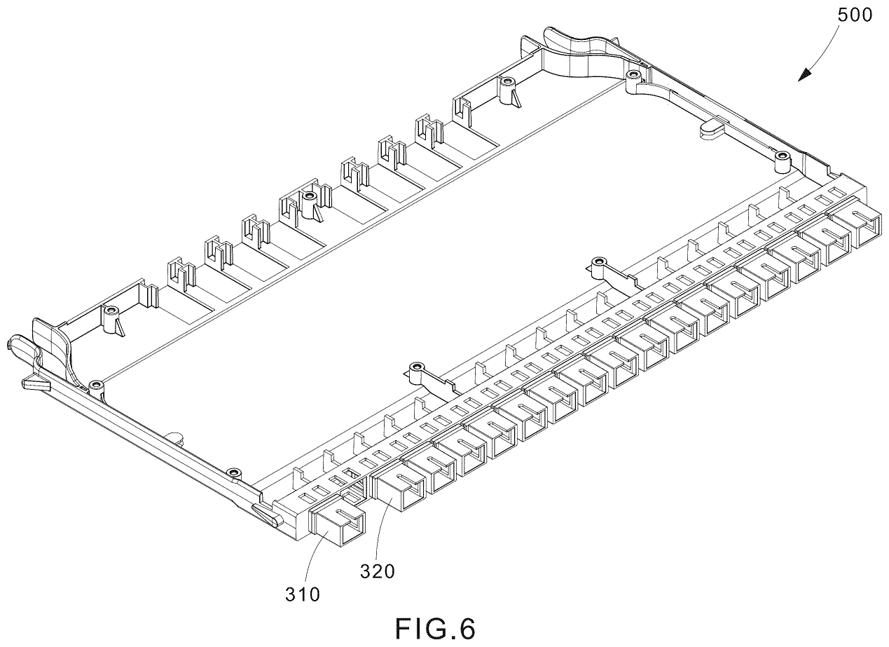

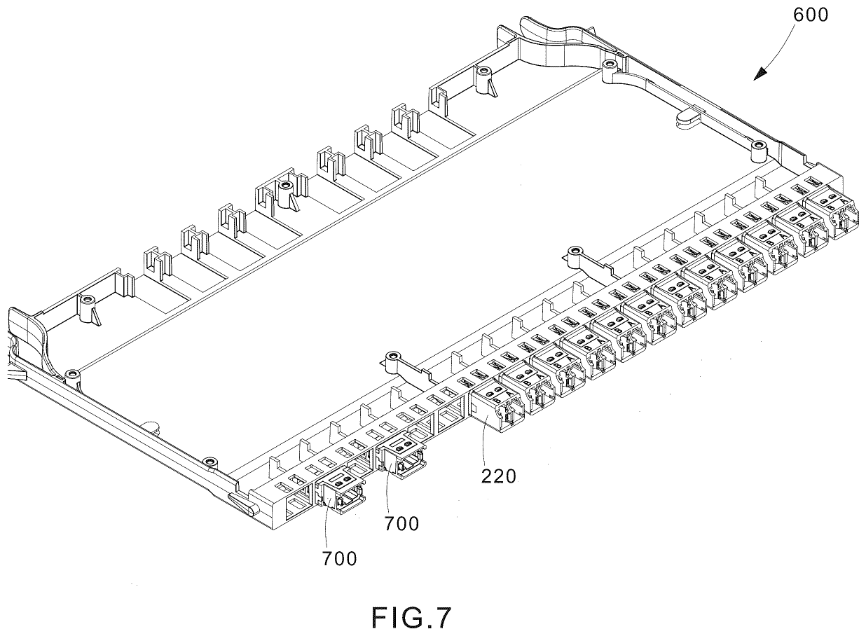

Using a mix of adapter types and adapter blanks, this cassette module 100 can be utilized in a variety of different configurations. For example, FIG. 5 shows an embodiment where the cassette module 100 has been configured into a cassette module 400 having a 1×32 LC splitter cassette configuration using a single duplex LC adapter 210 on a left-side as an input, and 16 duplex LC adapters 220 on a right-side as outputs, where unused front openings 112 are covered using blanking plugs. FIG. 6 shows an embodiment where the cassette module 100 has been configured into a cassette module 500 having a 1×16 SC splitter cassette configuration using a single SC adapter 310 on a left-side as an input, and 16 SC adapters 320 on a right-side as outputs, where unused front openings 112 are covered using blanking plugs. FIG. 7 shows an embodiment where the cassette module has been configured into a cassette module 600 having a 2×MPO+12 LC cassette configuration using two MPO adapters 700 on a left-side as inputs, and 12 duplex LC adapters 220 on a right-side as outputs, where unused front openings 112 are covered using blanking plugs. The inputs and outputs may also be flipped so that input adapters are on the right side, and the output adapters are on the left side, according to other embodiments.

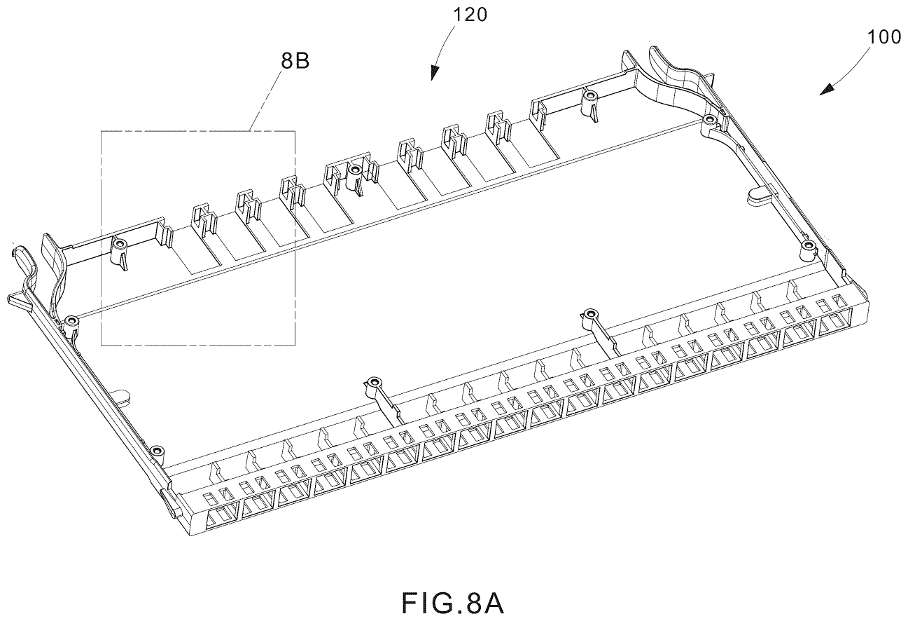

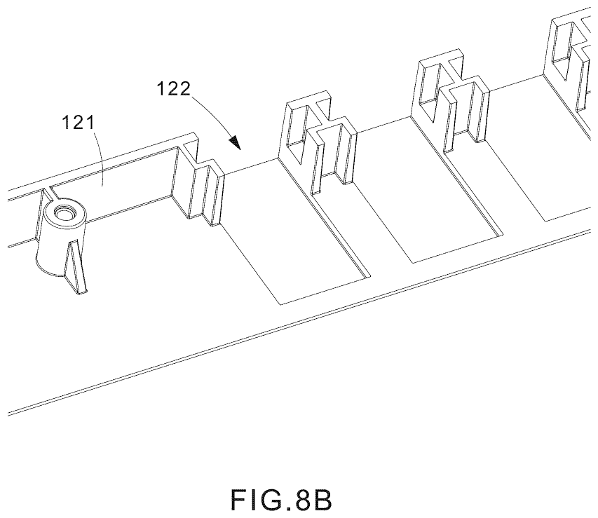

FIG. 8A shows a top-side perspective view of the cassette module 100. FIG. 8B shows a magnified view of a portion 8B from the cassette module 100 shown in FIG. 8A that focuses on the rear portion 120 of the cassette module 100. As shown in FIG. 8B, the rear portion 120 includes rear openings 122 along the rear wall 121 where adapters such as MPO adapters may be installed to enable front to rear fiber connectivity. The cassette module 100 is shown to include 8 rear openings 122, although other embodiments may include a different number of one or more rear openings 122.

Furthermore, while the particular embodiments described herein have been shown and described, it will be obvious to those skilled in the art that changes and modifications may be made without departing from the teachings of the cassette module described herein. Features shown but not described in detail may be the same as features from cassette modules described in, for example, U.S. Pat. Nos. 11,709,331 and/or 11,624,888, the entirety of which are incorporated by reference herein. The matter set forth in the foregoing description and accompanying drawings is offered by way of illustration only and not as limitation. The scope of the different embodiments described herein are intended to be defined in the following claims when viewed in their proper perspective.

What is claimed is:

1. A cassette module comprising:
a first side wall;
a second side wall;
a bottom floor;
a rear wall; and
a front portion including:
a front face;
a front ceiling;
a plurality of front openings;
a first set of mounting features; and
a second set of mounting features.

2. The cassette module of claim 1, wherein the first set of mounting features are configured to enable installation of a first type of connector adapter.

3. The cassette module of claim 1, wherein the first type of connector adapter is an LC type adapter.

4. The cassette module of claim 1, wherein the second set of mounting features are configured to enable installation of a second type of connector adapter.

5. The cassette module of claim 1, wherein the second type of connector adapter is an SC type adapter.

6. The cassette module of claim 1, wherein a width of each front opening is configured to enable installation of at least two different types of connector adapters.

7. The cassette module of claim 1, wherein a width of each front opening is configured to enable installation of at least three different types of connector adapters.

8. The cassette module of claim 1, wherein the plurality of front openings includes at least 18 openings.

9. The cassette module of claim 1, wherein the first set of mounting features are located on the front ceiling.

10. The cassette module of claim 1, wherein the second set of mounting features are integral with the front face.

11. The cassette module of claim 1, wherein the plurality of front openings includes a first front opening and a second front opening, wherein the first front opening and the second front opening are adjacent to each other, and a center-to-center distance between the first front opening and the second front opening is at least 0.60 inches.

12. The cassette module of claim 1, wherein the rear wall includes a rear opening configured to install a connector adapter.
